(19) United States
(12) Patent Application Publication
(10) Pub. No.: US 2007/0283427 A1
(43) Pub. Date: Dec. 6, 2007

(54) Simplified identity management of a common area endpoint

(75) Inventors: Anoop Gupta, Woodinville, WA (US); Dawson Yee, Bellevue, WA (US); Gurdeep S. Pall, Sammamish, WA (US); Rui Maximo, Issaquah, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/445,174

(22) Filed: Jun. 1, 2006

(51) Int. Cl. H04L 9/32

(52) U.S. Cl. 726/9

(57) ABSTRACT

Techniques are provided for configuring a device. A token including first information identifying a user is received. The first information is read from the token. The device is configured using the first information in accordance with configuration data for the user.

### BACKGROUND

Hotelling is a term that may be used to characterize configuring a work area on a temporary basis. Such configuration may be performed, for example, for a single location that may be used by a variety of different employees. The configuration may include configuring a device, such as a computer system, in the work area for each employee when using the work area. Different employees may utilize the same physical computer by logging on with different user ids. The computer may be configured in accordance with information associated with the currently logged on/active user id.

One existing technique for logging on includes performing user authentication with a user identifier and password. One drawback with the foregoing is that the password may be long and complex, and may also be changed at a prescribed frequency in accordance with a specified security policy. Due to the complexity and/or length of a password, a user may mistype his/her password taking several attempts before logging on successfully. A user may also forget a password depending on how frequently the account is used. Additionally, it can be tedious to maintain complex passwords due to the security policies such as requiring a password to be changed frequently as well as a high degree of difference between a new password and recently specified passwords.

Another existing technique for configuring a device is a technique for configuring a phone. A SIM (subscriber identity module) card may be inserted into a GSM phone and the phone operates in accordance with the phone number on the SIM card. Inserting a different SIM card in the same GSM phone causes the phone to be associated with a different phone number of the currently inserted SIM card.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques are provided for configuring a device. A token including first information identifying a user is received. The first information is read from the token. The device is configured using the first information in accordance with configuration data for the user.

### DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment illustrating an environment that may be utilized in connection with the techniques described herein;

FIG. 2 is an example of components that may be included in an embodiment of a device for use in connection with performing the techniques described herein;

FIG. 3 is an example of components that may be included in an embodiment of a registration server for use in connection with performing the techniques described herein;

FIG. 4 is an example illustrating data flow between components of FIGS. 1, 2 and 3 in connection with the techniques described herein; and

FIGS. 5 and 6 are flowcharts of processing steps that may be performed in an embodiment in connection with the techniques described herein.

### DETAILED DESCRIPTION

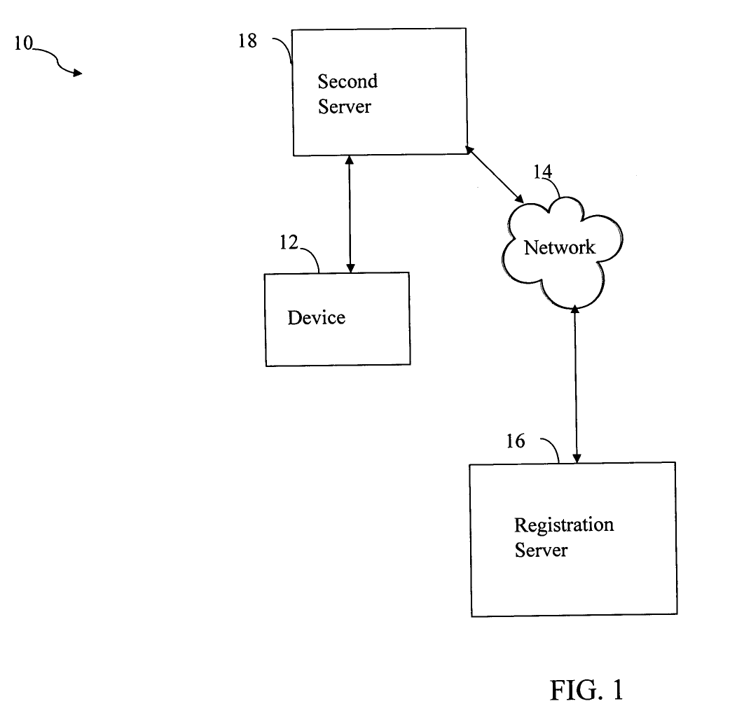

Referring now to FIG. 1, illustrated is an example of a suitable computing environment in which embodiments utilizing the techniques described herein may be implemented. The computing environment illustrated in FIG. 1 is only one example of a suitable computing environment and is not intended to suggest any limitation as to the scope of use or functionality of the techniques described herein in connection with device configuration. Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

Included in FIG. 1 are a device 12, a network 14, a registration server 16 and a second server 18. In the arrangement 10, the device 12 and second server 18 may be configured in a LAN. The second server 18 may communicate with the registration server 16 using the network 14. Logical communications to the device 12, for example, from the server 16 may be routed through the server 18.

The device 12 may be, for example, a phone, computer, PDA, or video conferencing components. The device may be a wireless or non-wireless device. The particular arrangements and devices used in examples herein are for purposes of illustrating the techniques described herein in connection with configuration of a device in accordance with configuration information associated with a user. Any device that has connectivity to the server 18 and having the functionality described herein may be included in an embodiment. Additionally, although a single device is illustrated in FIG. 1, an embodiment may include one or more devices. The device 12 may include a processor used to execute code included in one or more program modules. Described in more detail elsewhere herein are program modules that may be executed by the devices in connection with the techniques described herein. The device 12 may operate in a networked environment and communicate with the server 18 and other components not shown in FIG. 1. The server 18 may operate in a networked environment and communicate with the server 16 and other components also not shown in FIG. 1.

As will be described in following paragraphs, a user may register at a first point in time with the registration server 16. As part of the registration process, configuration data may be included in a user profile created for the user. The configuration data may include device configuration data for one or more devices. Also, as part of registration, a token may be initialized to include information used by the registration server 16 to identify the registered user. Initialization is described in more detail in following paragraphs and may vary with the particular token to enable the token to be used in connection with the techniques described herein. As described in following paragraphs, the token may also include other information such as configuration data. Subsequent to registration, the token may be used to automatically configure the device 12 in accordance with configuration data of the registered user.

The techniques described in following paragraphs allow a device to be configured for any registered user so that the device may be associated with the user. For example, rather than associate a phone with a phone number, the phone is associated with the user. When the device is configured for the registered user, communications for the user may be routed to the device. If the user performs the configuration process for a second device, subsequent communications for the user may be routed to the second device rather than the previously configured device for the user. As such, the techniques described herein may be used to have a device temporarily configured for a registered user.

As will also be described herein, the token initialized as part of registration is used to identify or represent the registered user to the registration server. Using the techniques described herein, the user is represented by the token and may connect to one or more devices on a temporary, or longer term, basis.

It will be appreciated by those skilled in the art that although the components of FIG. 1 are shown in the example as communicating in a networked environment, the components may communicate with other components utilizing different communication mediums. For example, the second server 18 may communicate with one or more components utilizing a network connection, and/or other type of link known in the art including, but not limited to, the Internet, an intranet, or other wireless and/or hardwired connection(s).

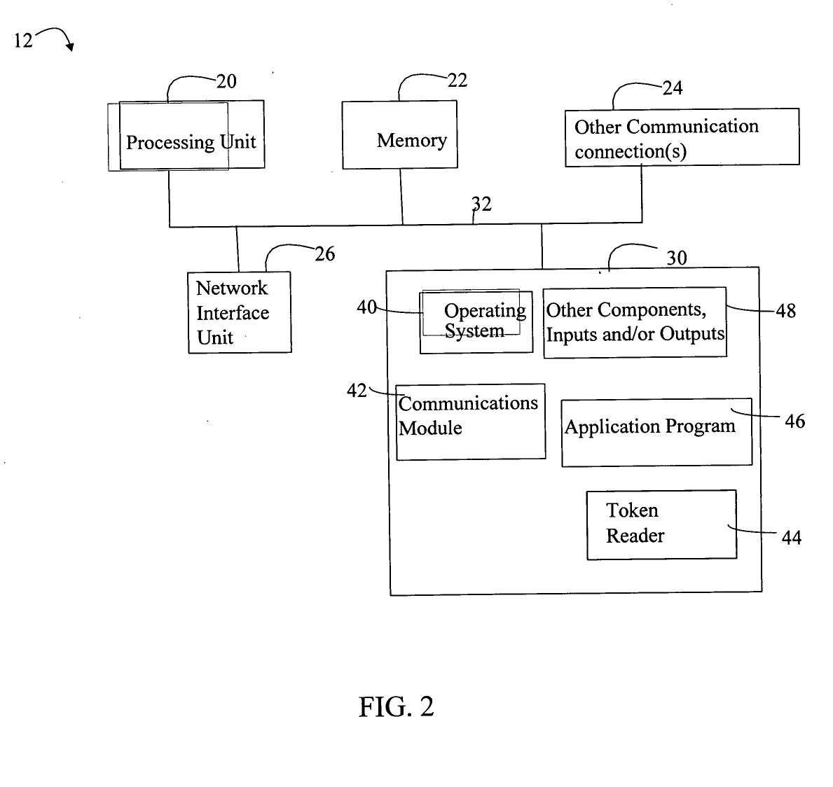

Referring now to FIG. 2, shown is an example of components that may be included in the device 12, as may be used in connection with performing the various embodiments of the techniques described herein. The device 12 may include one or more processing units 20, memory 22, a network interface unit 26, storage 30, one or more other communication connections 24, and a system bus 32 used to facilitate communications between the components of the device 12.

Depending on the configuration and type of device 12, memory 22 may be volatile (such as RAM), non-volatile (such as ROM, flash memory, etc.) or some combination of the two. Additionally, the device 12 may also have additional features/functionality. For example, the device 12 may also include additional storage (removable and/or non-removable) including, but not limited to, USB devices, magnetic or optical disks, or tape. Such additional storage is illustrated in FIG. 2 by storage 30. The storage 30 of FIG. 2 may include one or more removable and non-removable storage devices having associated computer-readable media that may be utilized by the device 12. The storage 30 in one embodiment may be a mass-storage device with associated computer-readable media providing non-volatile storage for the device 12. Although the description of computer-readable media as illustrated in this example may refer to a mass storage device, such as a hard disk or CD-ROM drive, it will be appreciated by those skilled in the art that the computer-readable media can be any available media that can be accessed by the device 12.

By way of example, and not limitation, computer readable media may comprise computer storage media and communication media. Memory 22, as well as storage 30, are examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by device 12. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The device 12 may also contain communications connection(s) 24 that allow the user's computer to communicate with other devices and components such as, by way of example, input devices and output devices. Input devices may include, for example, a keyboard, mouse, pen, voice input device, touch input device, etc. Output device(s) may include, for example, a display, speakers, printer, and the like. These and other devices are well known in the art and need not be discussed at length here. The one or more communications connection(s) 24 are an example of communication media.

In one embodiment, the device 12 may operate in a networked environment as illustrated in FIG. 1 using logical connections to remote computers and other components through a network. The device 12 may connect to a LAN including the device 12 and the second server 18. The device 12 may have such connections to the LAN through a network interface unit 26 connected to bus 32. The network interface unit 26 may also be utilized in connection with other types of networks and/or remote systems and components.

One or more program modules and/or data files may be included in storage 30. During operation of the device 12, one or more of these elements included in the storage 30 may also reside in a portion of memory 22, such as, for example, RAM for controlling the operation of the user computer 12. The example of FIG. 2 illustrates various components including an operating system 40, a communications module 42, a token reader 44, one or more application programs 46, and other components, inputs, and/or outputs 48.

The operating system 40 may be any one of a variety of commercially available or proprietary operating systems. The operating system 40, for example, may be loaded into memory in connection with controlling operation of the user computer. One or more application programs 46 may execute in the user computer 12 in connection with performing user tasks and operations. The particular application programs, if any, may vary with device.

The communications module 42 may be used by the device in facilitating communications between the device and other external components, such as the second server 18, to process any incoming/outgoing transmissions that may vary with the particular device.

The token reader module 44 may be used in connection with reading a token as may be initialized with information from the registration of a user as described elsewhere herein. The module 44 may be used to read information from the token, for example, when the token is inserted into the reader. An embodiment may use tokens which operate by coming into direct physical contact with the module 44. For example, the user may have a token which is a card, such as Smart Card. The card may be, for example, a pocket-sized card with embedded information thereon including information from the registration process used by the server 16 for identifying the user. The card may be physically inserted into a Smart Card or other card reader to obtain the information stored thereon. Other examples of tokens may include a USB-token, a SIM card, RFID tokens, and wireless Smart cards.

It should be noted that the module 44 may vary in accordance with the type of device used in an embodiment. The tokens that may be used in an embodiment in connection with the techniques described herein are not limited to those which may be characterized as requiring physical contact with the module 44. An embodiment may also use tokens operating without having the token come into direct physical contact with the module 44.

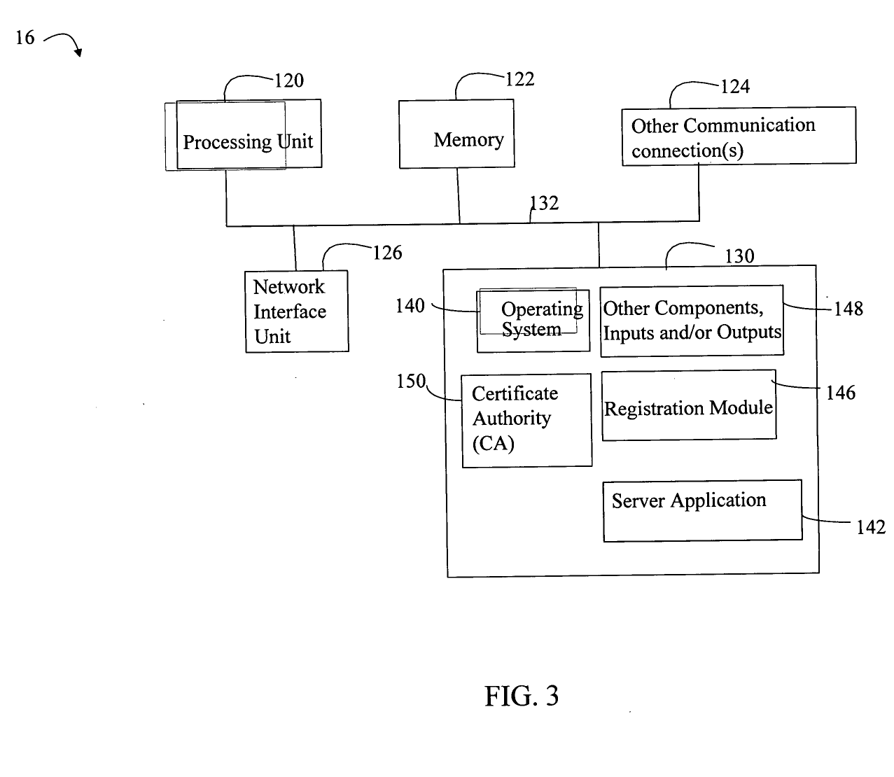

Referring now to FIG. 3, shown is an example of components that may be included in the registration server 16 and used in connection with performing the various embodiments of the techniques described herein. As illustrated in FIG. 3, an embodiment of the registration server 16 may include components similar to those described in connection with FIG. 2. Additionally, the server 16 may include a registration module 146, one or more server applications 142, and a certificate authority (CA) 150.

It should be noted that although the CA 150, registration module 146 and server application 142 are illustrated as residing on the same server, they may reside on one or more physical server systems. Such variations will be readily apparent and appreciated by those skilled in the art.

The one or more server applications 142 may be server applications performing services or tasks in accordance with the particular functionality included in an embodiment.

The certificate authority (CA) 150 is an authority that issues and manages security credentials and public keys for message encryption and decryption. As known in the art, the CA operates as part of a public key infrastructure (PKI). For example, the CA may issue digital certificates for use by other parties. The CA is an example of a trusted third party.

The registration module 14 is used in connection with registering users as part of a communication service. As part of the registration process, a user profile may be created which includes configuration data. The configuration data may include data used to configure one or more devices of varying types. The configuration data may be used in connection with the techniques described herein to configure the particular device in a customized fashion in accordance with a registered user. Configuration data may include, for example, a common set of data that applies to more than one device. Configuration data may also include device-specific data that varies with each device. Configuration data may also vary with a specific model or manufacturer of a device.

A token is initialized to include information identifying the registered user. As described in following paragraphs, the token is the element by which the server authenticates and identifies a registered user. Information on the token may be used by the registration server to authenticate and identify the registered user in connection with device configuration. The token for a registered user may be initialized as part of the registration process. The token may be initialized to include a digital certificate (which includes a public key), a private key, and a personal identifier, such as a user password or PIN (Personal Identification Number). The foregoing three pieces of information may be used in one embodiment in connection with identifying and authenticating a registered user with the techniques described herein for device configuration.

The digital certificate and private key may be obtained using the CA 150. In one embodiment, the CA 150 on the server 16 may generate the digital certificate and the private key and then store these data items on the token. In another embodiment, the token may include a form of storage and a processor. The CA may instruct the token to generate the private key and then store the private key on the token. The user password or PIN may be entered manually or otherwise by the user as part of registration. The user password or PIN may be used in connection with allowing a possessor of the token to utilize information stored on the token at a later time. The user password or PIN may be used to control whether the private key stored on the token is allowed to be used in connection with processing steps for device configuration. The use of the digital certificate, private key and personal identifier, such as a PIN or user password, is described in more detail in following paragraphs.

The configuration data may be stored on the server 16 and/or on the token. One or more factors may affect how the configuration data is apportioned for storage. One factor is the type of token and capabilities of the token. For example, the token may have limited storage capacity and an embodiment may store all the configuration data on the server 16. A second factor that may affect where the configuration data is stored is the type of configuration data. If the configuration data applies to multiple devices, the data may be stored on the token rather than on the server. Since the configuration data applies to multiple devices, it may be used more frequently. The data may be stored on the token to avoid having to download the data from the server 16.

It should be noted that configuration data may be retrieved from the token and/or server as needed in accordance with the particular device being configured.

It should also be noted that even though configuration data may be stored on the token, it may be that the particular module used to read the data is not capable of accessing such configuration data stored thereon.

Once the token is initialized, the registered user may utilize the token at a subsequent time to configure a device using the configuration data associated with the registered user's profile. Such device configuration can occur in an automated fashion with minimal user input.

What will now be described is an example of how the token may be used to configure a device for a registered user.

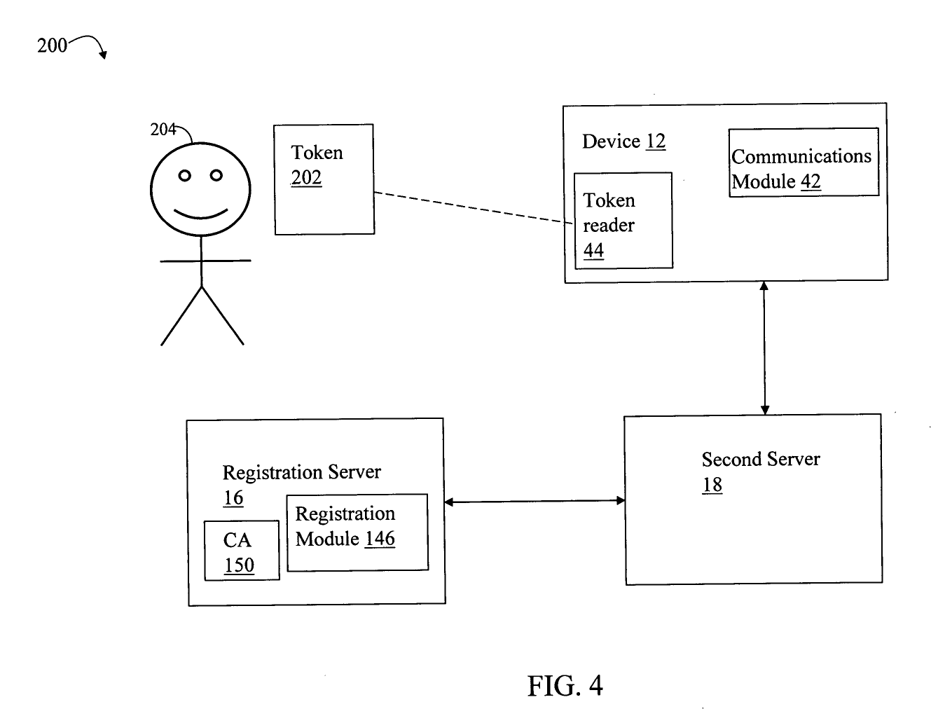

Referring now to FIG. 4, shown is an example 200 illustrating the data flow between components of a token, device and the servers in one embodiment for device configuration. It should be noted that the components of FIG. 4 make reference to similarly named components described elsewhere herein such as in connection with FIGS. 1, 2 and 3. It should be noted in the particular example of FIG. 4, the token 202 may include a processor and is able to execute instructions to perform various processing steps in connection with the techniques described herein. In an alternate embodiment in which the token 202 may not be capable of the foregoing, another component may perform the processing steps.

In the example 200, the registered user 204 has his/her token 202 which is initialized as described above. The token 202 may have been previously initialized as part of the registration process for the user 204 at the registration server 16. The token 202 may be read by the token reader 44, for example, as a result of inserting the token 202 into a slot or other opening of 44. The device 12, via the token reader 44, is able to read the information stored on the token 202. The device 12 enters a setup mode and the user is prompted to enter his/her password or PIN. The device 12 sends the user-entered data to the token. The token compares the user-entered data to the previously entered PIN or password from the registration process as stored on the token. The token notifies the device 12 with an indicator as to whether the user-entered data matches the PIN or password as stored on the token. If there is no match, the user is again prompted.

If there is a match, processing continues with the device sending a randomly generated string or other message to the token. The message will be used in subsequent processing steps. The token encrypts the message with the private key stored on the token. The encrypted message is returned by the token to the device with the digital certificate.

The device 12 then proceeds with authenticating the user to the registration server 16. If such authentication is successful, processing is performed to configure the device 12 using configuration data for the registered user represented by the token 202. The authentication process as may be performed in an embodiment will now be described in more detail.

The device 12 may communicate with the registration server 16 via the second server 18. However, in other embodiments, the device 12 may communicate directly with the server 16. Communications with the registration server 16 may be performed using any method of secure communications such as, for example, over an SSL (secure socket layer) connection, IPSEC tunneling, and the like. The device 12 transmits the digital certificate, the original message, and the encrypted message to the registration server 16.

At the server 16, the registration module 146 receives the communication transmitted from the device 12. The module 146 requests that the CA 150 perform processing to verify the digital certificate received. As known in the art, this includes, for example, using a certificate chain, revocation list, and the like, to verify the authenticity and genuineness of the digital certificate. The CA 150 notifies the registration module 146 regarding the verification results. Processing continues once the certificate has been successfully verified.

The registration module 146 extracts the public key from the digital certificate and decrypts the encrypted message received from the device. The decrypted message is compared to the original message. If there is a match, then the registration server 16 proceeds with downloading any configuration data stored at the server 16 to the device 12. The configuration data, if any, stored at the server 16 may be returned to the device 12 along with a successful status regarding the authentication of the user information as included on the token 202. Upon receiving the successful status, the device 12 proceeds with configuration in accordance with any received configuration data as well as any configuration data stored on the token 202.

When the user is done with the device 12, the user may remove the token 202 from the token reader 44. In one embodiment, removal of the token may terminate the association of the device with the registered user as identified by the token. In another embodiment, once the token is removed, the device may continue to operate as the registered user's device until the device is powered off. Other embodiments may also exhibit other behavior regarding when the association of the device with the registered user is terminated. The particular behavior may vary with device and one or more other policies in an embodiment.

It should be noted that any one of a variety of different techniques may be used in place of the PIN or password allowing processing to proceed with the private key stored on the token. For example, a biometric identifier and reader may be used in an embodiment. The biometric identifier may be a fingerprint, retinal scan, and the like. The particular technique and personal identifier used in connection with controlling access to the private key as stored on the token for processing purposes may vary with embodiment.

Once a device is configured for a registered user, the device may be used as an endpoint in a communications network. The device may be associated with the registered user and communications for the user may be routed to the device. An embodiment may allow a user to specify criteria to be used in connection with routing communications to the user on a currently configured device.

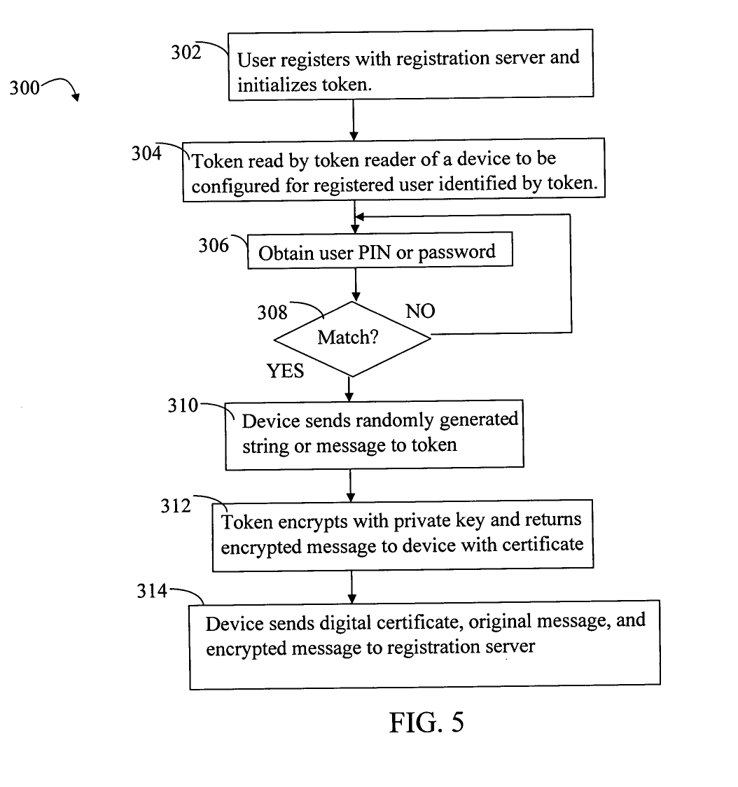

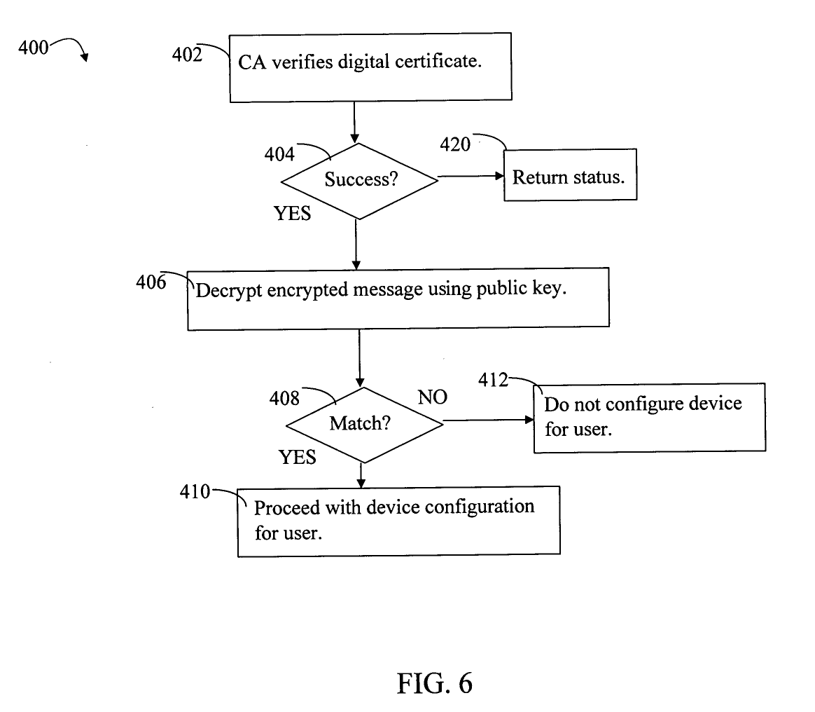

Referring now to FIGS. 5 and 6, shown are flowcharts of processing steps that may be performed in an embodiment in connection with the techniques described herein. The steps of flowcharts 300 and 400 summarize processing just described. At step 302, a user registers with the registration server and the user's token is initialized. The token is initialized to include information that may be subsequently used to identify the user and authenticate the user by the registration server. At a later point in time, the user performs steps to configure a device. At step 304, the token is read by a token reader on the device. The token may be inserted into an opening of the reader. Upon reading the token, the device enters setup mode and the user is prompted to enter a PIN or password at step 306. The token compares the user-entered PIN or password entered on the device from step 306 to the PIN or password stored on the token. At step 308, a determination is made as to whether the user-entered data matches the PIN or password from the token. If not, control proceeds to step 306 where the user is prompted to reenter the input. Otherwise, if step 308 evaluates to yes, control proceeds to step 310. At step 310, the devices sends a randomly generated string or other message to the token. At step 312, the token encrypts the message with the private key stored on the token and returns the encrypted message to the device with the digital certificate. At step 314, the device sends the digital certificate, original message, and encrypted message to the registration server requesting that the registration server authenticate the registered user as represented by the transmitted data.

The flowchart 400 of FIG. 6 sets forth processing steps that may be performed in one embodiment in connection with this authentication processing by the registration server At step 402, the CA verifies the received digital certificate. At step 404, a determination is made as to whether the verification was successful. If not, control proceeds to step 420 to return a status indicating the failure. If step 404 evaluates to yes, control proceeds to step 406 where the encrypted message is decrypted using the public key included in the digital certificate. At step 408, a determination is made as to whether the decrypted message matches the original message. If not, control proceeds to step 412 where processing is performed so that the device is not configured. Step 412 may result, for example, in returning a message to the device indicating a failure status. If step 408 evaluates to yes, control proceeds to step 410. At step 410, processing is performed to proceed with device configuration for the registered user. Step 410 may include, for example, returning a message to the device indicating successful authentication of the user and forwarding any configuration data as stored on the registration server. The device then proceeds with configuration in accordance with the configuration data received from the registration server and/or stored on the token.

As will be appreciated by those skilled in the art, other techniques besides the public/private key techniques described herein may be used in an embodiment.

It should be noted that the second server 18, although not described in further detail herein, may also include hardware and/or software components similar to those described in connection with FIG. 3 in accordance with the particular processing performed by the server 18.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of configuring a device comprising:
receiving a token including first information identifying a user;
reading said first information from said token; and
configuring a device using said first information in accordance with configuration data for the user.

2. The method of claim 1, further comprising:
performing processing to authenticate the user using a portion of said first information.

3. The method of claim 1, further comprising:
communicating with a registration module to verify that said first information identifies a registered user.

4. The method of claim 1, wherein said device is configured on a temporary basis.

5. The method of claim 1, wherein said token is used to configure a plurality of different devices for a same user.

6. The method of claim 1, wherein said device is a phone.

7. The method of claim 1, wherein said device is a computer.

8. The method of claim 1, wherein said device is a mobile communications device.

9. The method of claim 1, wherein a first portion of said configuration data is stored on the token and a second portion of the configuration data is stored on a registration server.

10. The method of claim 9, wherein said token is initialized with said first information as part of registration of said user.

11. The method of claim 1, wherein said first information includes a private key, a digital certificate, and a personal identifier.

12. The method of claim 11, wherein said personal identifier is used to control whether processing is allowed using the private key.

13. The method of claim 11, wherein said personal identifier is a biometric indicator.

14. The method of claim 1, wherein said device is used in connection with video conferencing.

15. The method of claim 11, wherein said token includes a processor thereon used to generate the private key.

16. The method of claim 1, wherein said device is an endpoint in a communication path and communications to the user are routed to the device.

17. The method of claim 1, further comprising:
inserting said token into a token reader;
entering input data; and
determining whether said input data matches a personal identifier included in said first information on said token.

18. The method of claim 17, wherein, if said input data matches said personal identifier, subsequent processing is performed using a private key included in said first information on said token.

19. A computer readable medium comprising executable code for configuring a device comprising code that:
receives a token including first information identifying a user;
reads said first information from said token;
performing processing to authenticate the user using a portion of said first information; and
configures a device using said first information in accordance with configuration data for the user.

20. A method of configuring a device comprising:
receiving a token including first information identifying a user;
reading said first information from said token;
communicating with a registration module to verify that said first information identifies said user as a registered user;
configuring a device using said first information in accordance with configuration data for the user; and
forwarding communications for said user to said device for a duration while said device is configured for said user.
